(19) United States
(12) Patent Application Publication
(10) Pub. No.: US 2002/0129509 A1
(43) Pub. Date: Sep. 19, 2002

(54) Reinforced blade end for a retractable tape measure

(75) Inventor: John Joseph Evans III, Johns Island, SC (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: L.S. Starrett Co.

(21) Appl. No.: 09/812,023

(22) Filed: Mar. 19, 2001

(51) Int. Cl. G01B 3/10

(52) U.S. Cl. 33/757

(57) ABSTRACT

The present invention provides a retractable measuring tape having a blade with increased strength at the outer end of the blade. The measuring tape includes a housing for holding a retractable blade and a aperture through which the retractable blade extends. The retractable blade has an inner end affixed within the housing and an outer end having an attachment to prevent the outer end of said blade from entering the housing. The outer end of said blade member including a reinforcement material. The reinforcing materials include thermoplastic polymers, thermosetting polymers and metals. A preferred class of reinforcing materials are thermoplastic polymers such as: polyamides like nylons and aramids; polyesters like poly(ethylene terephthalate); acrylics; polycarbonates; polystyrenes; polysulfones and poly(vinyl chlorides). Another class of reinforcing materials includes thermosetting polymers: such as phenolics; epoxies; polyurethanes; and silicones. Yet another class of reinforcing materials includes ferrous and a non-ferrous metals such as: steel, aluminum and titanium. Lastly other reinforcing materials such as fiberglass and graphite may be used.

### BACKGROUND OF THE INVENTION

(1) Field of the Invention

This invention relates to a hand held retractable measuring tape having a reinforced blade end. More particularly, the invention relates to a retractable measuring tape blade that has a reinforcing material as part of the outer end of the blade providing increased strength at the blade end.

(2) The Prior Art

Retractable measuring tapes have a retractable metal tape blade retained within a casing. Inside the casing, the retractable blade is maintained in a wound state by a spring-tension reel. The end of the blade extending from the case has a tip or finger tab attachment that prevents the outer end of the blade from entering into the case. One significant problem with conventional retractable measuring tapes is that during use, the tape blade is repeatedly bent and kinked, which produces alternating or fluctuating stresses at the outer end of the tape blade. These stresses in the tape blade results in weakening the metal tape blade and eventually, can lead to the tape blade breaking due to fatigue failure proximate to one of these areas of high stress. Blade end failures may also result from excessive whipping of the blade end attachment against the tape housing as the blade is retracted into the housing, particularly if blade retraction is assisted by a spring return. In this regard, it has been found that a professional builder or someone in a similar or related occupation can wear out a tape blade in three to four months.

By way of background, there is a problem with breakage in the outermost end, i.e., the first two feet of retractable tapes in that the outermost end receives by far the most wear and about 70% of the tape measure blades that break, break in the outermost end.

Retractable tapes generally provide metal plates that increase the thickness and strength at the blade end. However, in reality, such devices merely move the line of breakable from the extremity of the tape to the junction where the reinforcement plates are attached to the tape. The common supported metal blade results in a rigid blade end structure adjoining a relatively weak and fragile unsupported blade. This junction of the blade and structure and the blade becomes a line of high stress since the blade will tend to bend about a line at that junction when the blade end attachment is caught in the work piece. Repeated or severe bending, of course, results in fracture of the blade at this line.

Manufacturers and distributors of retractable measuring tapes often offer a lifetime guarantee against defects or breakage of the tape measure blade. Since the casing of most retractable measuring tapes is sealed, the casing is generally not accessible to effect repair of the blade tape in the event the tape blade breaks. Even if disassembly of the casing is possible by removing the fasteners or screws in the casing, attempts to repair the tape blade can be dangerous due to the energy retained in the spring-tension reel. Consequently, the manufacturer or distributor normally replaces the entire tape measure, which is not only expensive, but also wastes the remaining useful life of those parts that are not defective or broken.

In seeking better repairable tape measures, it is desirable to have a tape measure blade which has improved strength toward the blade tip end. One such example of a tape measure having a reinforced blade end is disclosed in Canadian Patent No. 1,193,853 to Evans, which discloses a tape measure blade having a specifically designed reinforcement member secured to the blade in such a way that it will resist tearing and breaking action. Such reinforced blade tip end resists flexing and blade tip damage caused by whipping action of the blade, especially at the extreme end of the blade tip as it is rewound. That is, the tough tip end significantly reduces blade breakage at the juncture between the blade end and the finger tap; however, there remains blade breakage in the section adjacent to the tough tip end.

Thus, there remains a need for a retractable measuring tape having a blade end that has improved resistance to breakage and can be filly retracted into the housing.

### SUMMARY OF THE INVENTION

In accordance with the present invention there is provided a hand held retractable measuring tape having a tape blade in which a reinforcing material is part of the outer end of the blade providing increased strength at the blade end. The retractable measuring tape includes a housing for holding a retractable blade and an aperture through which the retractable blade extends. The retractable blade has an inner end affixed within the housing and an outer end having an attachment to prevent the outer end of the blade from entering the housing. The outer end of the blade includes a reinforcement material.

The reinforcing materials that may be used to form the reinforced blade of the measuring tapes of the present invention include thermoplastic polymers, thermosetting polymers and metals. A preferred class of reinforcing materials are thermoplastic polymers such as: polyamides like nylons and aramids; polyesters like poly(ethylene terephthalate); acrylics; polycarbonates; polystyrenes; polysulfones and poly(vinyl chlorides). Another class of reinforcing materials includes thermosetting polymers: such as phenolics; epoxies; polyurethanes; and silicones. Yet another class of reinforcing materials includes ferrous and a non-ferrous metals such as: steel, aluminum and titanium. Lastly other reinforcing materials such as fiberglass and graphite may be used.

The reinforcing material may be applied to the blade end by any variety of methods known to those skilled in the art such as laminating, coating and the like. Either through adhesives, adhesive tapes, fused (heat, ultrasonic, solvents), are riveted directly to the blade end. In addition to a laminated film, the reinforcing material can also be applied as a shrink-tube over the end of the blade. The reinforcing material is applied to either side of the blade or both sides.

The material is applied to a maximum thickness up to about 10 mils so that the blade will bend as it is retracted into the housing. A preferred thickness is about 2 to 3 mils. The reinforcing material extends from the outer end of said blade end for a length of about 6 inches to about 12 inches.

### BRIEF DESCRIPTION OF THE DRAWINGS

The foregoing and other advantages and features of the invention, and the matter in which the same are accomplished, will become more readily apparent upon consideration of the following detailed description of the invention taken in conjunction with the accompanying drawings, which illustrate the preferred and exemplary embodiments, and which are not necessarily drawn to scale, and wherein:

FIG. 1 is a perspective view illustrating an embodiment of a tape measure according to the present invention;

FIG. 2 is an enlarged bottom view of a blade member showing a metal hook attached to a blade tip of the prior art;

FIG. 3 is an enlarged top view showing a first embodiment of a blade end with a reinforcing material as part o f the upper surface of the blade as shown along line 3-3 of FIG. 2; and

FIG. 4 is an enlarged bottom view showing a second embodiment of a blade end with a reinforcing material as part of the bottom surface of the blade.

### DETAILED DESCRIPTION OF THE INVENTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

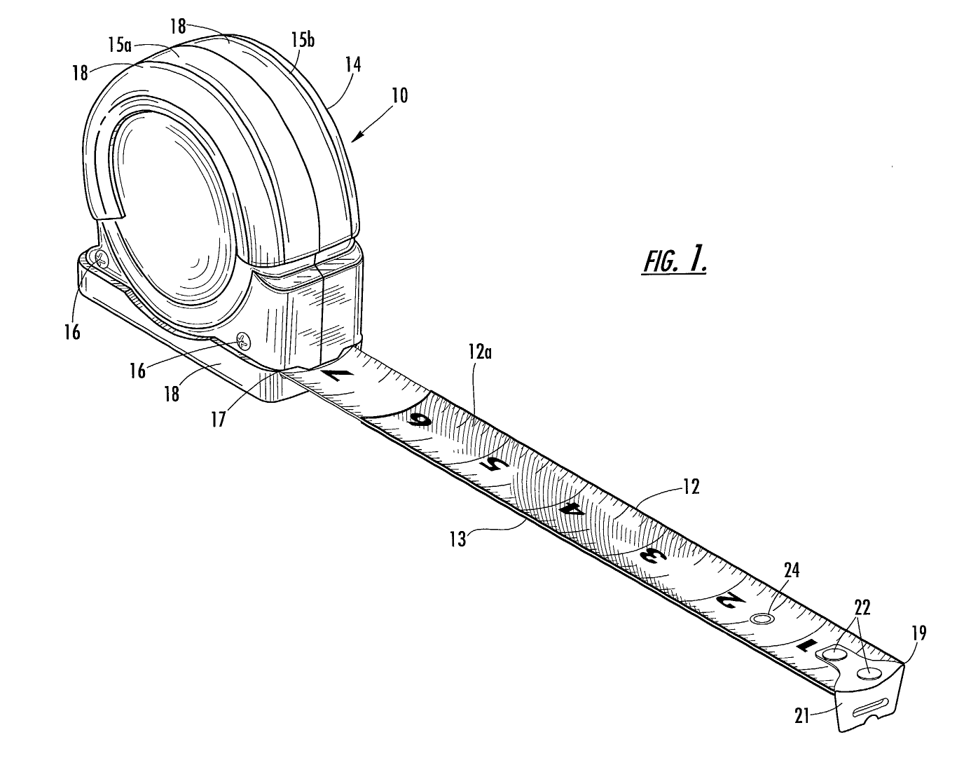

Referring to the drawings, and in particular to FIG. 1, there is shown a hand-held measuring tape 10 having a housing 14 for holding a retractable blade 12 in the housing and an aperture 17 through which the retractable blade 12 extends. The retractable blade 12 has an inner end affixed within said housing (not shown) and an outer end 19 having an attachment to prevent the outer end 19 of the blade 12 from entering the housing. The tape blade 12 is coiled about a spring-tensioned reel that is rotatable within the housing 14. The blade 12 has a concave upper surface 12a and a convex lower surface 12b. The housing 14 can be constructed of a variety of materials, such as metal or injection molded plastic. Preferably, the housing is constructed by forming first and second halves 15a, 15b of molded plastic, which halves may be secured together by any one of a number of conventional means, including adhesive and/or metal fasteners such as screws 16.

To assist the user in gripping the measuring tape 10, a high friction covering 18 may be applied to selected portions of the housing. The high friction covering is preferably constructed of an elastomer having a textured outer surface. A label (not shown) provides pertinent information to the tape measure can be attached about the exterior of one or both halves of the housing. A belt clip (not shown) may also be attached to the exterior of the housing so that the measuring tape can be conveniently secured to the user's clothing.

As illustrated in FIG. 1, the retractable measuring tape 10 with blade member 12 in an extended position from the housing 14 and has an attachment 20 on the outer end of the blade to prevent the outer end from enter the housing when the blade is retracted. The attachment may be any one of the well-know attachments used for this purpose. As shown in FIG. 1, attachment 20 is a finger tab 21 affixed to the blade tip 19 by rivets 22. Optionally, the outer end 19 of blade 12 may be fitted with a tough tip 22 shown as a metal reinforcing member and is held by eyelet 24 (or rivet) to blade member 12. The other end of tough tip 22 is secured to convex lower surface 12b of blade member 12 by two rivets 22, which also secures the supporting end of finger tab 21 to concave upper surface 12a.

FIG. 2 provides an enlarged view of the concave upper surface of the outer end of blade 12. There is shown a coating 13 on the concave upper surface 12a. At the outer end 19 of the blade 12 there is an attachment 20 that prevents the blade end 19 from entering the housing. As shown in FIG. 2 the attachment 20 is a finger tab 21 affixed to the blade tip 19 by rivets 22. The outer end 19 of blade 12 may be fitted with a tough tip 22 shown as a metal reinforcing member and is held by eyelet 24 to blade member 12. The other end of tough tip 22 is secured to convex lower surface 12b of blade member 12 by two rivets 22, which also secures the supporting end of finger tab 21 to concave upper surface 12a.

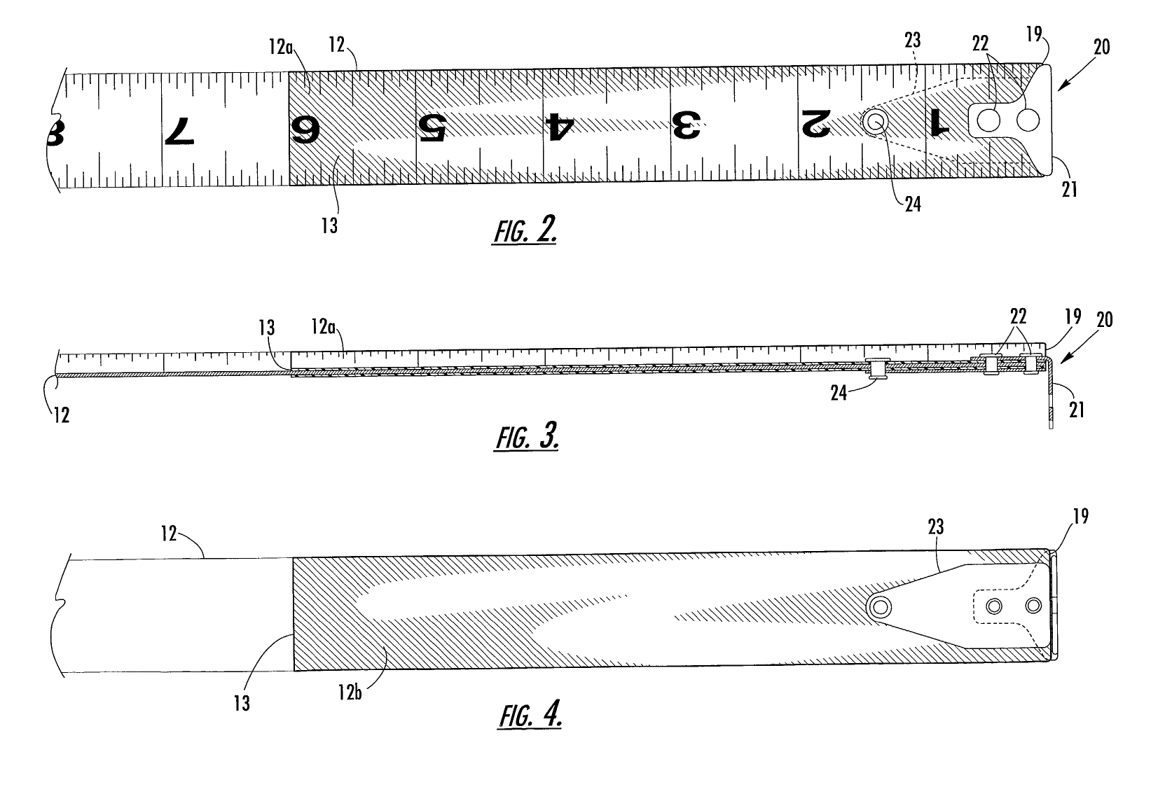

As illustrated in FIG. 3, there is an enlarged side view of an extended blade 12 that is taken along line 3-3 of FIG. 2. The blade is a one-inch wide heavy duty tape measure blade and is composed of 0.005 inches thick high carbon steel coated with a paint and top coat layer of an overall thickness of approximately 0.007 inches. There is a layer of transparent reinforcing material 13 applied to the concave upper surface 12a of the blade. The reinforcing material 13 is thin enough to allow the blade to fully retract into the tape housing. There is also shown an attachment 20 at the outer end 19 of the blade having a tab 21 held to said blade tip by pilot 24 and rivets 22.

FIG.4 provides and enlarged view of another embodiment of the present invention showing the convex lower surface 12b of the outer end of blade 12. In this embodiment, the reinforcing material 13 is affixed to the underside or convex lower surface 12b of the outer end of blade 12. In this embodiment, the reinforcing material 13 may be transparent, but it is not necessary for there to be transparency of the reinforcing material in this embodiment.

The reinforcing material may be a thermoplastic polymer, a thermosetting polymer or a metal. A preferred class of reinforcing materials are thermoplastic polymers such as: polyamides like nylons and aramids (Kevlar®); polyesters like poly(ethylene terephthalate); acrylics; polycarbonates; polystyrenes; polysulfones; and poly(vinyl chlorides). Another class of reinforcing materials includes thermosetting polymers, such as: phenolics; epoxies; polyurethanes; and silicones. Yet another class of reinforcing materials includes ferrous and a non-ferrous metals such as: steel; aluminum; and titanium. Lastly other reinforcing materials such as fiberglass and graphite may be used.

The reinforcing material may be applied to the blade end by any variety of method known to those skilled in the art such as laminating, coating and the like. Either through adhesives, adhesive tapes, fused (heat, ultrasonic, solvents), are riveted directly to the blade end. In addition to a laminated film, the reinforcing material can also be applied as a shrink-tube over the end of the blade. The reinforcing material is applied to either side of the blade or both sides. A preferred embodiment, the reinforcing material is transparent, especially if applied to the front side of the blade over the printed graduations, if the reinforcing material is applied to the front of the blade prior to the printing process, transparency is not an issue. If the reinforcing material is placed on the backside of the blade, the material does not necessarily need to be transparent. The material is applied to a maximum thickness up to about 10 mils. so that the blade will bend as it is retracted into the housing. A preferred thickness is about 2-3 mils. The reinforcing material extends from the outer end of said blade end for a length of about 6 inches to about 12 inches. . A total thickness of 0.010 inch will generally allow the tape to still coil properly into the tape case; however, the total thickness and the tape's ability to rewind will be dependent upon the choice of reinforcement material.

As an alternative to laminated or film-type reinforcements, include heavier applications of coatings, including acrylics, nylons, lacquers, UV coatings, polyurethanes, powder coatings, epoxies, vinyl esters, and polyesters.

Another reinforcing method includes evaluating a heavier extrusion at the beginning of the tape blade. This extrusion would be composed of any thermosetting or thermoplastic material. Any of these reinforcing methods could be applied to ½ inch, ¾ inch, 1 inch, 1¼ inch or 1½ inch blades, as well as other width tape measure blades. In addition to reinforced blade materials, the present invention is applicable to hybrid blades that are traditional steel blades attached to composite blades for improved durability.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A hand held measuring tape comprising:
a housing for holding a retractable blade and an aperture through which said retractable blade extends;
said retractable blade having an inner end affixed within said housing and an outer end having an attachment to prevent said outer end of said blade from entering said housing;
said outer end of said blade member including a thermoplastic reinforcement material.

2. The measuring tape according to claim 1 wherein said thermoplastic reinforcing material is a polymer selected from the group consisting of polyamides, polyesters, acrylics, polycarbonates, polystyrenes, polysulfones and poly(vinyl chlorides).

3. The measuring tape according to claim 2 wherein said thermoplastic reinforcing material is a nylon.

4. The measuring tape according to claim 1 wherein said thermoplastic reinforcing material is laminated to said blade end.

5. The measuring tape according to claim 1 wherein said thermoplastic reinforcing material is coated on said blade end.

6. The measuring tape according to claim 1 wherein said thermoplastic reinforcing material is fused to said blade end.

7. The measuring tape according to claim 1 wherein said thermoplastic reinforcing material is up to about 10 mils in thickness.

8. The hand held measuring tape according to claim 1 wherein said thermoplastic reinforcing material extends from the outer end of said blade end for a length of about 6 inches to about 12 inches.

9. A hand held measuring tape comprising:
a housing for holding a retractable blade and an aperture through which said retractable blade extends;
said retractable blade having an inner end affixed within said housing and an outer end having an attachment to prevent said outer end of said blade from entering said housing;
said outer end of said blade member including a thermoplastic polymer selected from the group consisting of polyamides, polyesters, acrylics, polycarbonates, polystyrenes, polysulfones and poly(vinyl chlorides), and said polymer is applied in a thickness for about 2 to 3 mils.

10. A hand held measuring tape comprising:
a housing for holding a retractable blade and an aperture through which said retractable blade extends;
said retractable blade having an inner end affixed within said housing and an outer end having an attachment at the tip to prevent said outer end of said blade from entering said housing;
said outer end of said blade including a thermosetting reinforcement material.

11. The hand held measuring tape according to claim 10 wherein said thermosetting reinforcing material is a member of the group consisting of phenolics; epoxies; polyurethanes; and silicones.

12. The measuring tape according to claim 10 wherein said thermosetting reinforcing material is laminated to said blade end.

13. The measuring tape according to claim 10 wherein said thermoplastic reinforcing material is coated on said blade end.

14. The measuring tape according to claim 10 wherein said thermoplastic reinforcing material is fused to said blade end.

15. The measuring tape according to claim 10 wherein said thermoplastic reinforcing material is up to about 10 mils in thickness.

16. The hand held measuring tape according to claim 10 wherein said thermosetting reinforcing material extends from the outer end of said blade end for a length of about 6 inches to about 12 inches.

17. A hand held measuring tape comprising:
a housing for holding a retractable blade and an aperture through which said retractable blade extends;
said retractable blade having an inner end affixed within said housing and an outer end having an attachment at the tip to prevent said outer end of said blade from entering said housing;
said outer end of said blade including a metal reinforcement material.
